(19) United States
(12) Patent Application Publication
(10) Pub. No.: US 2012/0181963 A1
(43) Pub. Date: Jul. 19, 2012

(54) INITIAL POSITION DETECTION FOR A SENSORLESS, BRUSHLESS DC MOTOR

(75) Inventor: Xiaoyan Wang, Plano, TX (US)

(73) Assignee: Texas Instruments Incorporated, Dallas, TX (US)

(21) Appl. No.: 13/009,538

(22) Filed: Jan. 19, 2011

(51) Int. Cl. H02P 6/20

(52) U.S. Cl. 318/400.33

(57) ABSTRACT

Because there is a desire to migrate to sensorless, brushless direct current (DC) motors in large scale applications (i.e., vehicles), there is a need to provide a control system for such motors in large scale applications. Here, a motor controller is provided that uses small voltage pulses to generate currents (which are sufficiently small so as to not commute the motor) through pairs of phases. Based on the rise times of these currents, the motor controller can determine the initial position by using a lookup table (LUT) without commuting the motor.

### TECHNICAL FIELD

The invention relates generally to initial position detection and, more particularly, to initial position detection for a sensorless, brushless direct current (DC) motor.

### BACKGROUND

For most large motor applications (i.e., vehicles), Hall-effect sensors are employed to determine rotor position. These sensors, however, increase cost and are generally unreliable, so it is desirable to eliminate these sensors, similar to what has been done with small motor applications (i.e., hard disk drives). There are some issues associated with large scale applications (i.e., maintaining initial position at startup) that may make direct application of the small scale solutions inapplicable. Therefore, there is a need for a method and/or apparatus to determine the initial position of a motor while maintaining the initial position.

Some examples of convention methods and/or apparatuses are: U.S. Pat. No. 5,028,852; U.S. Pat. No. 7,072,778; U.S. Pat. No. 5,191,270; and U.S. Pat. No. 7,334,854.

### SUMMARY

A preferred embodiment of the present invention, accordingly, provides an apparatus. The apparatus comprises a sensing circuit; and a microcontroller having a memory with a lookup table (LUT) stored thereon, wherein the microcontroller generates 2N voltage pulses for 2N pairs of phases of a sensorless, brushless direct current (DC) motor having N phases, and wherein the microcontroller is coupled to the sensing circuit so as to determine a phase inductance from a current for each of the 2N pairs of phases of the DC motor, and wherein the microcontroller determines an initial position of the DC motor from the LUT by using the phase inductance from the current for each of the 2N pairs of phases of the DC motor.

In accordance with a preferred embodiment of the present invention, the apparatus further comprises a pre-driver that is coupled to the microcontroller so as to output the 2N voltage pulses.

In accordance with a preferred embodiment of the present invention, the pre-driver further comprises a level shifter, and wherein the apparatus further comprises a communication port that is coupled to the microcontroller.

In accordance with a preferred embodiment of the present invention, the sensing circuit further comprises: an amplifier; and an analog-to-digital converter (ADC) that is coupled to the amplifier and the microcontroller, wherein the ADC digitizes a measurement of the current for each of the 2N pairs of phases of the DC motor.

In accordance with a preferred embodiment of the present invention, the sensing circuit further comprises: an amplifier; a comparator that is coupled to the amplifier and the pre-driver; and a register that is coupled between the comparator and the communication port, wherein the register is adapted to provide an interrupt signal to the microcontroller to indicate that the current for each of the 2N pairs of phases of the DC motor reaches a predetermined threshold so that the microcontroller can determine a rise time of the current for each of the 2N pairs of phases of the DC motor.

In accordance with a preferred embodiment of the present invention, the apparatus further comprises a digital-to-analog converter (DAC) that is coupled between the communication port and the comparator so as to provide a reference voltage to the comparator.

In accordance with a preferred embodiment of the present invention, the apparatus further comprises a comparison circuit that is coupled to the DC motor and the microcontroller so as to perform back electromotive force (back-EMF) zero-cross detection to commute the DC motor.

In accordance with a preferred embodiment of the present invention, N is 3.

In accordance with a preferred embodiment of the present invention, a method for determining an initial position of a sensorless, brushless DC motor having N phases is provided. The method comprises providing 2N voltage pulses for 2N pairs of phases of the DC motor; sensing a current for each of the 2N pairs of phases of the DC motor, wherein the current for each of the 2N pairs of phases of the DC motor is sufficiently small so as to maintain the initial position of a rotor of the DC motor; determining a phase inductance for the current for each of the 2N pairs of phases of the DC motor; and comparing the phase inductance for the current for each of the 2N pairs of phases of the DC motor to an LUT to determine the initial position.

In accordance with a preferred embodiment of the present invention, the DC motor is a three-phase motor having a first phase, second phase, and third phase, and wherein N is 3.

In accordance with a preferred embodiment of the present invention, the current for each of the N pairs of phases of the DC motor further comprises first, second, third, fourth, fifth, and sixth currents, and wherein the steps of providing further comprises: providing a first voltage pulse that generates the first current, wherein the first current traverses the first and second phases in order; providing a second voltage pulse that generates the second current, wherein the second current traverses the second and first phases in order; providing a third voltage pulse that generates the third current, wherein the third current traverses the first and third phases in order; providing a fourth voltage pulse that generates the fourth current, wherein the fourth current traverses the third and first phases in order; providing a fifth voltage pulse that generates the fifth current, wherein the fifth current traverses the second and third phases in order; and providing a sixth voltage pulse that generates the sixth current, wherein the sixth current traverses the third and second phases in order.

In accordance with a preferred embodiment of the present invention, the phase inductance for the current for each of the N pairs of phases further comprise first, second, third, fourth, fifth, and sixth phase inductances, which respectively correspond to the first, second, third, fourth, fifth, and sixth currents, and wherein the step of comparing further comprises comparing the first, second, third, fourth, fifth, and sixth phase inductances to the LUT to determine the initial position.

In accordance with a preferred embodiment of the present invention, the step of determining further comprises measuring a rise time to reach a threshold for each of the first, second, third, fourth, fifth, and sixth currents.

In accordance with a preferred embodiment of the present invention, the step of determining further comprises measuring a voltage across a sense resistor at a predetermined time for each of first, second, third, fourth, fifth, and sixth currents.

In accordance with a preferred embodiment of the present invention, an apparatus is provided. The apparatus comprises a sensorless, brushless DC motor having N phases; actuation circuitry that is coupled to the DC motor; a motor controller having: a sensing circuit that is coupled to the actuation circuitry; a pre-driver that is coupled to the actuation circuitry; a microcontroller having a memory with an LUT stored thereon, wherein the microcontroller is coupled to the sensing circuit and the pre-driver, and wherein the microcontroller: generates 2N voltage pulses for 2N pairs of phases, wherein the 2N voltage pulses are provided through the pre-driver; determines a phase inductance for a current for each of the 2N pairs of phases of the DC motor; and determines an initial position of the DC motor from the LUT by using the phase inductance for the current for each of the 2N pairs of phases of the DC motor.

In accordance with a preferred embodiment of the present invention, N is 3, and wherein the motor controller further comprises: a communication port that is coupled to the microcontroller; a comparison circuit that is coupled to the DC motor and the microcontroller so as to perform back-EMF zero-cross detection to commute the DC motor; and a DAC that is coupled between the communication port and the comparator so as to provide a reference voltage to the comparator.

In accordance with a preferred embodiment of the present invention, the actuation circuit further comprises: a driver that is coupled to the pre-driver; a plurality of power transistors, wherein each power transistor is coupled to and controlled by the driver; and a sense resistor that is coupled to at least one of the power transistors and the amplifier.

In accordance with a preferred embodiment of the present invention, the apparatus further comprises an attenuator that is coupled between the DC motor and the comparison circuit, and wherein the comparison circuit further comprises plurality of zero-crossing comparators that are each coupled to the attenuator.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of an example of a system in accordance with a preferred embodiment of the present invention;

FIGS. 2A, 2B, and 3 are diagrams of examples of the operation of the motor controller of FIG. 1;

FIG. 4 is diagram of an example of the motor controller of FIG. 1;

FIG. 5 is diagram of an example of the sensing circuit of FIG. 4; and

FIG. 6 is diagram of an example of the comparison circuit of FIG. 4.

### DETAILED DESCRIPTION

Refer now to the drawings wherein depicted elements are, for the sake of clarity, not necessarily shown to scale and wherein like or similar elements are designated by the same reference numeral through the several views.

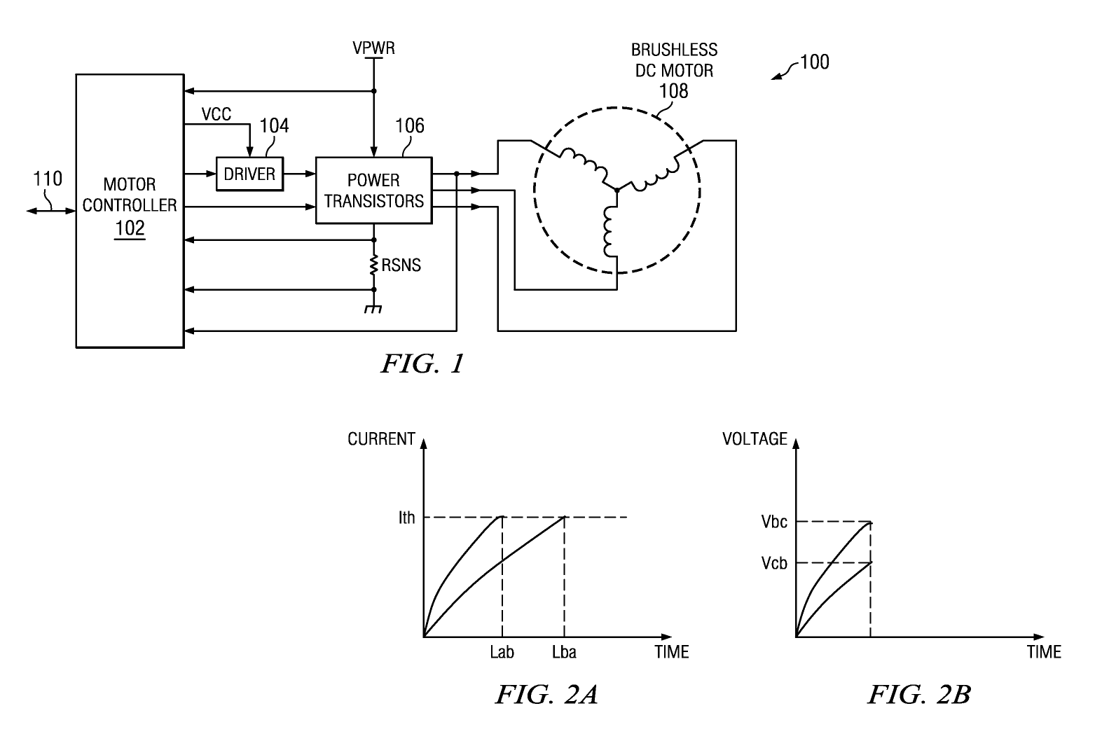

Turning to FIG. 1, an example of a system 100 can be seen. The system 100 generally comprises a motor controller 102, actuation circuit (which can include driver 104, power transistors 106, and sense resistor RSNS), and a sensorless, brushless DC motor 108. When determining the initial position of the motor 108, the motor controller 102 (which can itself be controlled or programming through communication channel 110 that can use one or more communication architectures, like inter-integrated circuit (I²C) or Universal Asynchronous Receiver/Transmitter (UART)) generates voltage pulses that engage pairs of phases of the motor 108. The current that traverses the pairs of phases of the motor 108 can be sensed with the sense resistor RSNS (which can, for example, be 500 mΩ) and should be sufficiently small so as to maintain the initial position be sufficiently large enough for detection (i.e., about 2 A for about 1 ms). Specifically, the motor controller 102 can measure the rise times for these currents or measure voltages at a predetermined interval or time to determiner phase inductance because there is a correlation between the phase inductance and current rise times (which can be seen in FIGS. 2A and 2B).

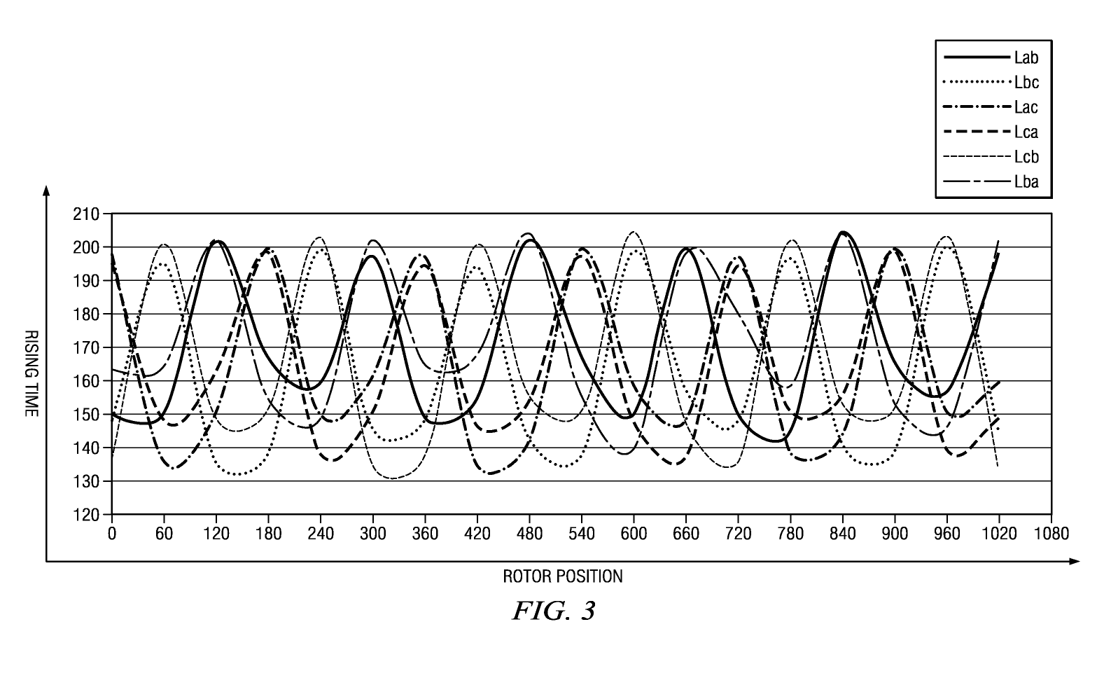

To make this determination of the initial position of the rotor of motor 108, the motor controller 102 uses voltage pulses (of which are double the number of phases of the motor) so as to engage all permutations of pairs of phases. For example, if motor 108 is assumed to be a three-phase motor (i.e., phases A, B, and C), then there would be six voltage pulses VAB, VBA, VAC, VCA, VBC, and VCB where the currents traverse the phases in order. For example, for pulse VAB, the current traverses phase A and phase B in order, while for pulse VBA, the current would traverse phase B and phase A in order. Looking to FIG. 3, the phase inductance for pairs AB, BA, AC, CA, BC, and CB (labeled LAB, LBA, LAC, LCA, LBC, and LCB, respectively) can be seen with respect to rotor position so that initial rotor position of motor 108 can be determined within 60 degrees. Preferably, a lookup table (LUT) can be used to make the determination of rotor position; an example of which can be seen in Table 1 below.

TABLE 1

| Rotor | | | |
|---|---|---|---|
| Position | Phase Inductance | | |
| 0° | LAB + LBA > LAC + LCA | LBC < LCB | LCA > LAC |
| | LAB + LBA > LBC + LCB | | |
| 60° | LAC + LCA > LAB + LBA | LAB > LBA | LBC < LCB |
| | LAC + LCA > LBC + LCB | | |
| 120° | LBC + LCB > LAB + LBA | LAB > LBA | LCA < LAC |
| | LBC + LCB > LAC + LCA | | |
| 180° | LAB + LBA > LAC + LCA | LBC > LCB | LCA < LAC |
| | LAB + LBA > LBC + LCB | | |
| 240° | LAC + LCA > LAB + LBA | LAB < LBA | LBC > LCB |
| | LAC + LCA > LBC + LCB | | |
| 360° | LBC + LCB > LAB + LBA | LAB < LBA | LCA > LAC |
| | LBC + LCB > LAC + LCA | | |

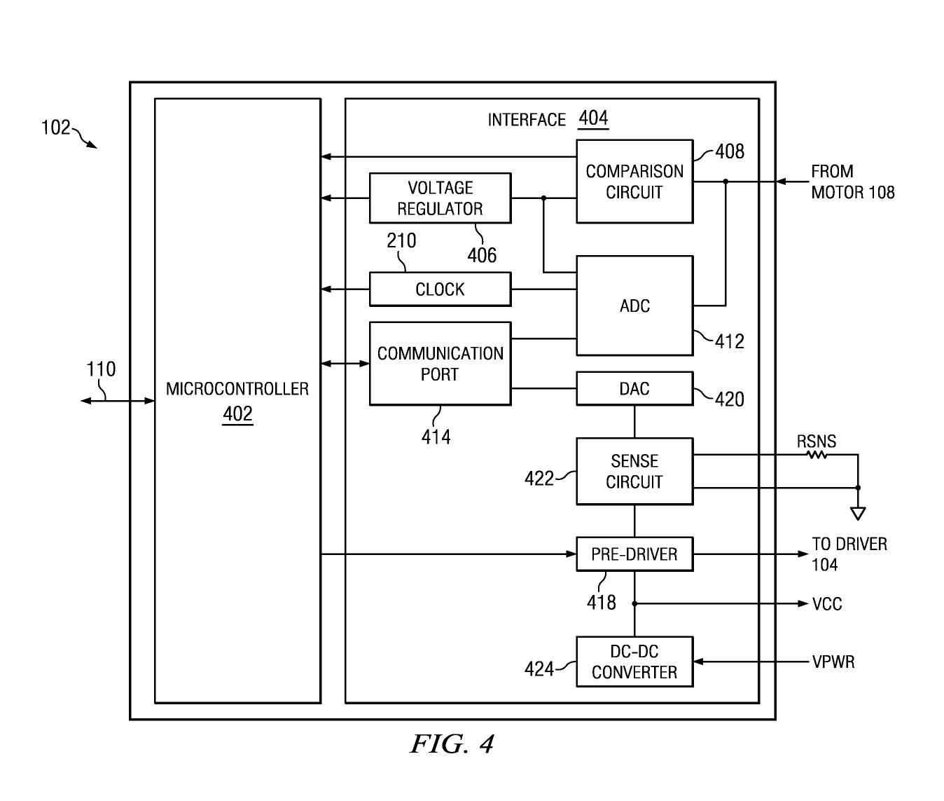

Turning to FIG. 4, the motor controller 102 can be seen in greater detail. The motor controller 102 is typically an integrated circuit or IC that is coupled to external components (i.e., sense resistor RSNS), and the motor controller 102 generally comprises a microcontroller 402 (which can, for example, be an 8-bit reduced instruction set (RISC) processor having a memory) and an interface 404. The interface 404 generally comprises a voltage regulator 406, a comparison circuit 408, a clock 210 (which can, for example, provide a 50 MHz clock signal), an analog-to-digital converter (ADC) 412, a communication port 414 (which can, for example, provide communications to the microcontroller 402 through a serial peripheral interface (SPI) protocol), a pre-driver 418 (which can include level shifters), a digital-to-analog converter (DAC) 420, a DC-DC converter 424, and a sense circuit 422. The voltage regulator 406 (which can, for example, include one or more low dropout (LDO) voltage regulators) that can regulate the supply voltage VCC from the DC-DC converter 424 (which can be between about 8V and 15V with a typical voltage of about 12V). The comparison circuit 408 (which is described in greater detail below) and the ADC 412 provide signals to the microcontroller 402 to enable normal operation of the motor 108. The pre-driver 418 (which can, for example, include one or more level shifters) provides the voltage signals (i.e., VAB) to driver 104 so as to enable normal operation of the motor or to determine the initial position of the rotor of the motor 108. Additionally, the sense circuit 408 and DAC 420 (which are described in greater detail below) enable initial position detection and over-current detection (during normal operation). The DC-DC converter 424 (which is typically a buck converter) provides supply voltage VCC from power supply voltage VPWR (i.e., between about 20V to about 100V with a typical voltage of about 48V). The DC-DC converter 424 can also include several external components (i.e., inductors and capacitors which are external to the IC).

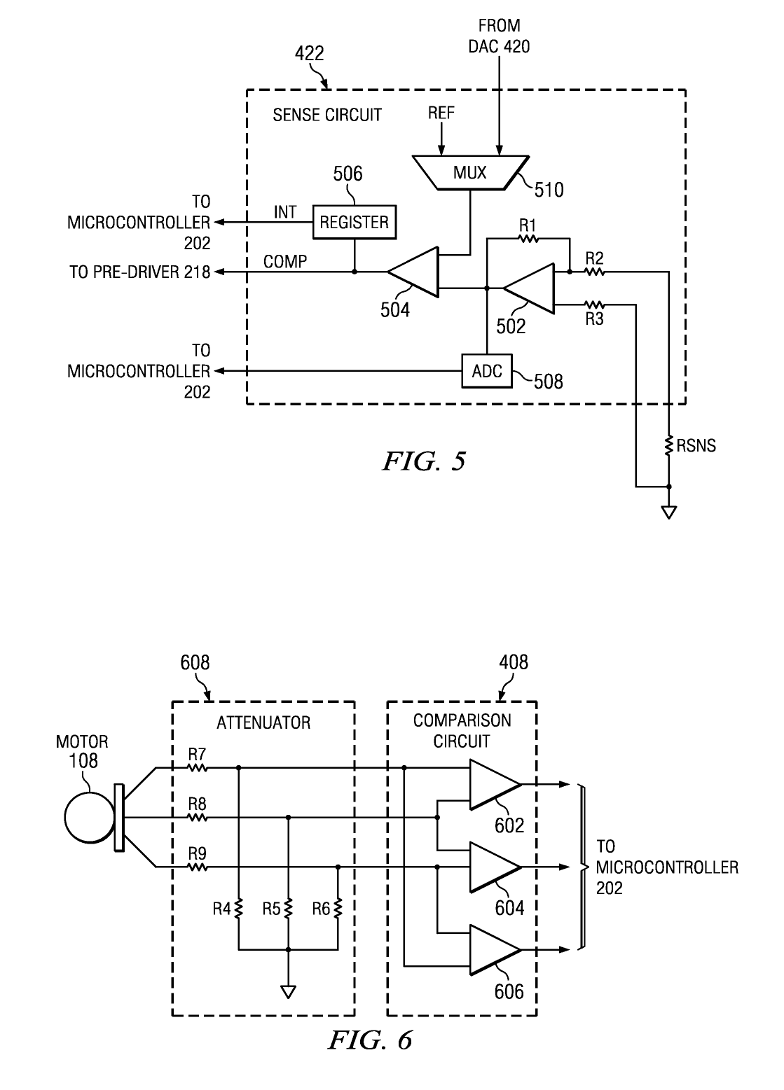

In FIG. 5, the sense circuit 402 can be seen in greater detail. This sense circuit 402 can provide two functions: over-current detection during normal operation and current sense to determine the initial position at startup. Additionally, there are two different methods that may be employed to determine initial position: rise time measurement and voltage measurement. The sense circuit 402 generally includes an amplifier 502, current-limit comparator 504, multiplexer or mux 510, register 506, and ADC 508. Generally, amplifier 502 (which, in conjunction with resistors R1 through R3, can provide a gain of between about 1 and about 4) amplifies the voltage drop across the sense resistor RSNS (which corresponds to current traversing a pair of phases of motor 108 during initial position detection). This amplified sense voltage can then be used during startup and during normal operation.

For a voltage measurement to determine initial position at startup, ADC 508 is used. In particular, ADC 508 digitizes the amplified sense voltage. Since the current traversing pairs of phases of motor 108 is proportional to the amplified sense voltage, the ADC 508 effectively digitizes a measurement of this current at a predetermine time or interval (as shown in FIG. 2B). The digitized measurements are then provided to microcontroller 202 through the communication port 414 so that the microcontroller 202 can determine the phases inductances directly from the voltage measurements. Based on calculated phase inductances, microcontroller 202 can determine the initial position of the rotor of motor 108 as described above.

For a rise time measurement to determine initial position at startup, comparator 504 is used. Generally, amplifier 502 measures current (similar to the voltage measurement described above), and the amplified sense voltage (from amplifier 502 and resistors R1 through R3) is then compared to a reference voltage by comparator 504. The reference voltage can be either an internal reference voltage REF (which can be about 1.2V and which can, for example, be supplied by a bandgap circuit) or a voltage provided by DAC 420 (which can be set by the microcontroller 102 so as to adjust the comparator threshold that corresponds to a current threshold for motor 108) through mux 510. Typically, the internal reference voltage REF is used for rise time measurements. Once the amplified sense current becomes greater than the reference voltage (applied to comparator 504), the comparator output COMP sets an over-current bit in register 506 so as to generate an interrupt signal INT to microcontroller 202. The microcontroller 202 (which typically uses an accurate clock) can the determine the rise time from the interrupt signal INT and can, thus, determine the phase inductances. Based on calculated phase inductances, microcontroller 202 can determine the initial position of the rotor of motor 108 as described above.

During normal operation, over-current detection is provided with comparator 504. Comparator 504 and register 506 operate in a similar manner to the method for rise time measurement described above. For normal operation, however, the threshold for the comparator 504 is usually set through the DAC 420. When the comparator output COMP then reflects whether the threshold of comparator 504 has been exceeded (which indicates an over-current condition), an over-current bit is set in register 506. The register 506 can then provides an interrupt signal INT to microcontroller 202 when the over-current bit is set. At about the same time, the comparator output COMP (which reflects an over-current condition) powers down the pre-driver 218 so as to “skip” pulse-width modulation (PWM) pulses until motor 108 falls below the current threshold (set by DAC 420 or internally).

Turning to FIG. 6, an example of the comparison circuit 408 can be seen in greater detail. Because motor 108 is a sensorless motor (i.e., does not include Hall sensors), the comparison circuit 408 uses back electromotive force (back-EMF) zero-cross detection to control motor commutation. As shown in the example of FIG. 6, motor 108 has three phases, and, correspondingly, comparison circuit 408 uses three zero-crossing comparators 602, 604, and 606. These comparators 602, 604, and 606 use for voltages from the phases of motor 108 determine the “state” of the motor 108, but coupled between the comparators 602, 604, and 606 and motor 108 is an attenuation circuit 608 (which generally comprises resistors R4 through R9) that can be used to attenuated the voltages from the motor 108. Based on the outputs of the comparators 602, 604, and 606, the microcontroller 202 can control commutation of the motor 108.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. An apparatus comprising:
a sensing circuit; and
a microcontroller having a memory with a lookup table (LUT) stored thereon, wherein the microcontroller generates 2N voltage pulses for 2N pairs of phases of a sensorless, brushless direct current (DC) motor having N phases, and wherein the microcontroller is coupled to the sensing circuit so as to determine a phase inductance from a current for each of the 2N pairs of phases of the DC motor, and wherein the microcontroller determines an initial position of the DC motor from the LUT by using the phase inductance from the current for each of the 2N pairs of phases of the DC motor.

2. The apparatus of claim 1, wherein the apparatus further comprises a pre-driver that is coupled to the microcontroller so as to output the 2N voltage pulses.

3. The apparatus of claim 2, wherein the pre-driver further comprises a level shifter, and wherein the apparatus further comprises a communication port that is coupled to the microcontroller.

4. The apparatus of claim 3, wherein the sensing circuit further comprises:
an amplifier; and
an analog-to-digital converter (ADC) that is coupled to the amplifier and the microcontroller, wherein the ADC digitizes a measurement of the current for each of the 2N pairs of phases of the DC motor.

5. The apparatus of claim 3, wherein the sensing circuit further comprises:
an amplifier;
a comparator that is coupled to the amplifier and the pre-driver; and
a register that is coupled between the comparator and the communication port, wherein the register is adapted to provide an interrupt signal to the microcontroller to indicate that the current for each of the 2N pairs of phases of the DC motor reaches a predetermined threshold so that the microcontroller can determine a rise time of the current for each of the 2N pairs of phases of the DC motor.

6. The apparatus of claim 5, wherein the apparatus further comprises a digital-to-analog converter (DAC) that is coupled between the communication port and the comparator so as to provide a reference voltage to the comparator.

7. The apparatus of claim 3, wherein the apparatus further comprises a comparison circuit that is coupled to the DC motor and the microcontroller so as to perform back electromotive force (back-EMF) zero-cross detection to commute the DC motor.

8. The apparatus of claim 7, wherein N is 3.

9. A method for determining an initial position of a sensorless, brushless DC motor having N phases, the method comprising:
providing 2N voltage pulses for 2N pairs of phases of the DC motor;
sensing a current for each of the 2N pairs of phases of the DC motor, wherein the current for each of the 2N pairs of phases of the DC motor is sufficiently small so as to maintain the initial position of a rotor of the DC motor;
determining a phase inductance for the current for each of the 2N pairs of phases of the DC motor; and
comparing the phase inductance for the current for each of the 2N pairs of phases of the DC motor to an LUT to determine the initial position.

10. The method of claim 9, wherein the DC motor is a three-phase motor having a first phase, second phase, and third phase, and wherein N is 3.

11. The method of claim 10, wherein the current for each of the N pairs of phases of the DC motor further comprises first, second, third, fourth, fifth, and sixth currents, and wherein the steps of providing further comprises:
providing a first voltage pulse that generates the first current, wherein the first current traverses the first and second phases in order;
providing a second voltage pulse that generates the second current, wherein the second current traverses the second and first phases in order;
providing a third voltage pulse that generates the third current, wherein the third current traverses the first and third phases in order;
providing a fourth voltage pulse that generates the fourth current, wherein the fourth current traverses the third and first phases in order;
providing a fifth voltage pulse that generates the fifth current, wherein the fifth current traverses the second and third phases in order; and
providing a sixth voltage pulse that generates the sixth current, wherein the sixth current traverses the third and second phases in order.

12. The method of claim 11, wherein the phase inductance for the current for each of the N pairs of phases further comprise first, second, third, fourth, fifth, and sixth phase inductances, which respectively correspond to the first, second, third, fourth, fifth, and sixth currents, and wherein the step of comparing further comprises comparing the first, second, third, fourth, fifth, and sixth phase inductances to the LUT to determine the initial position.

13. The method of claim 12, wherein the step of determining further comprises measuring a rise time to reach a threshold for each of the first, second, third, fourth, fifth, and sixth currents.

14. The method of claim 12, wherein the step of determining further comprises measuring a voltage across a sense resistor at a predetermined time for each of first, second, third, fourth, fifth, and sixth currents.

15. An apparatus comprising:
a sensorless, brushless DC motor having N phases;
actuation circuitry that is coupled to the DC motor;
a motor controller having:
a sensing circuit that is coupled to the actuation circuitry;
a pre-driver that is coupled to the actuation circuitry;
a microcontroller having a memory with an LUT stored thereon, wherein the microcontroller is coupled to the sensing circuit and the pre-driver, and wherein the microcontroller:
generates 2N voltage pulses for 2N pairs of phases, wherein the 2N voltage pulses are provided through the pre-driver;
determines a phase inductance for a current for each of the 2N pairs of phases of the DC motor; and
determines an initial position of the DC motor from the LUT by using the phase inductance for the current for each of the 2N pairs of phases of the DC motor.

16. The apparatus of claim 15, wherein N is 3, and wherein the motor controller further comprises:
a communication port that is coupled to the microcontroller;
a comparison circuit that is coupled to the DC motor and the microcontroller so as to perform back-EMF zero-cross detection to commute the DC motor; and
a DAC that is coupled between the communication port and the comparator so as to provide a reference voltage to the comparator.

17. The apparatus of claim 16, wherein the sensing circuit further comprises:
an amplifier;
an ADC that is coupled to the amplifier and the microcontroller wherein the ADC digitizes a measurement of the current for each of the 2N pairs of phases of the DC motor.

18. The apparatus of claim 16, wherein the sensing circuit further comprises:
an amplifier;
a comparator that is coupled to the amplifier and the pre-driver; and
a register that is coupled between the comparator and the communication port, wherein the register is adapted to provide an interrupt signal to the microcontroller to indicate that the current for each of the 2N pairs of phases of the DC motor reaches a predetermined threshold so that the microcontroller can determine a rise time of the current for each of the 2N pairs of phases of the DC motor.

19. The apparatus of claim 18, wherein the actuation circuit further comprises:
a driver that is coupled to the pre-driver;
a plurality of power transistors, wherein each power transistor is coupled to and controlled by the driver; and
a sense resistor that is coupled to at least one of the power transistors and the amplifier.

20. The apparatus of claim 19, wherein the apparatus further comprises an attenuator that is coupled between the DC motor and the comparison circuit, and wherein the comparison circuit further comprises plurality of zero-crossing comparators that are each coupled to the attenuator.
